(19) United States
(12) Patent Application Publication
(10) Pub. No.: US 2021/0027449 A1
(43) Pub. Date: Jan. 28, 2021

(54) SYSTEM AND METHOD FOR DETERMINING FIELD CHARACTERISTICS BASED ON DATA FROM MULTIPLE TYPES OF SENSORS

(71) Applicant: CNH Industrial America LLC, New Holland, PA (US)

(72) Inventor: Luca Ferrari, Modena (IT)

(73) Assignee: CNH Industrial America LLC

(21) Appl. No.: 16/519,087

(22) Filed: Jul. 23, 2019

(51) Int. Cl. G06T 7/00; H04N 5/225; A01B 76/00

(52) U.S. Cl. CPC G06T 7/0002; H04N 5/2254; G01S 13/865; G06T 2207/30188; A01B 76/00

(57) ABSTRACT

A system for determining a field characteristic during the performance of an agricultural operation includes a vision-based sensor configured to capture vision data indicative of a field characteristic of the field, as well as a secondary sensor configured to capture secondary data indicative of the field characteristic. The system also includes a controller configured to receive the vision data from the vision-based sensor and secondary data from the secondary sensor for use in determining the field characteristic. The controller is further configured to determine when the received vision data is occluded, and, when it is determined that the vision data is occluded, to determine the field characteristic based on the secondary data.

### FIELD OF THE INVENTION

The present disclosure generally relates to agricultural machines and, more particularly, to systems and methods for determining field characteristics during the performance of an agricultural operation based on data from multiple types of sensors.

### BACKGROUND OF THE INVENTION

Tillage implements, such as cultivators, disc harrows, and/or the like, perform one or more tillage operations while being towed across a field by a suitable work vehicle, such as in agricultural tractor. In this regard, tillage implements often include one or more sensors mounted thereon to monitor various characteristics associated with the performance of such tillage operations. For example, some tillage implements include one or more vision-based sensors (e.g., LIDAR sensors) that capture vision data of the soil within the field. Thereafter, such vision data may be processed or analyzed to determine one or more field characteristics, such as clod size, soil roughness, residue coverage, and/or the like.

The performance of a tillage operation typically generates large amounts of dust or other airborne particulate matter within the field. When dust/airborne particulate is present within the field(s) of view of the vision-based sensor(s), the data captured by the sensor(s) may be occluded, obscured, or otherwise of low-quality. Such occluded/obscured data may, in turn, provide an inaccurate determination(s) of the field characteristic(s).

Accordingly, an improved system and method for determining field characteristics during the performance of an agricultural operation would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for determining field characteristics during the performance of an agricultural operation. The system may include an agricultural machine configured to perform an agricultural operation on a field across which the agricultural machine is traveling. The system may also include a vision-based sensor provided in operative association with the agricultural machine, with the vision-based sensor configured to capture vision data indicative of a field characteristic of the field. Furthermore, the system may include a secondary sensor provided in operative association with the agricultural machine, with the secondary sensor configured to capture secondary data indicative of the field characteristic. Additionally, the system may include a controller communicatively coupled to the vision-based sensor and the secondary sensor. As such, the controller may be configured to receive the vision data from the vision-based sensor and secondary data from the secondary sensor for use in determining the field characteristic. Moreover, the controller may be configured to determine when the received vision data is occluded. In addition, when it is determined that the vision data is occluded, the controller may be configured to determine the field characteristic based on the secondary data.

In another aspect, the present subject matter is directed to a method for determining field characteristics during the performance of an agricultural operation. The method may include receiving, with one or more computing devices, vision data and secondary data providing an indication of a field characteristic of a field on which the agricultural operation is being performed. Furthermore, the method may include determining, with the one or more computing devices, when the received vision data is occluded. Additionally, when it is determined that the vision data is occluded, the method may include determining, with the one or more computing devices, the field characteristic based on received secondary data.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural machine in accordance with aspects of the present subject matter;

FIG. 2 illustrates a side view of one embodiment of a vision-based sensor and a secondary sensor of an agricultural machine in accordance with aspects of the present subject matter;

FIG. 3 illustrates a schematic view of one embodiment of a system for determining field characteristics during the performance of an agricultural operation in accordance with aspects of the present subject matter; and

FIG. 4 illustrates a flow diagram of one embodiment of a method for determining field characteristics during the performance of an agricultural operation in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for determining field characteristics during the performance of an agricultural operation. Specifically, in several embodiments, a controller of the disclosed system may be configured to receive vision data from one or more vision-based sensors (e.g., a LIDAR sensor(s)) and secondary data from one or more secondary sensors (e.g., a RADAR sensor(s)) during the performance of the agricultural operation. The vision data and the secondary data may, in turn, provide an indication of one or more characteristics (e.g., a residue characteristic, a clod size, a soil roughness, and/or the like) of a field on which the agricultural operation is being performed. Furthermore, the controller may be configured to determine when the received vision data is occluded or obscured (e.g., due to a dust cloud or other airborne particulate matter). In this regard, when it is determined that the vision data is not occluded/obscured, the controller may be configured to ignore the secondary data and determine the field characteristic (s) based on the received vision data. Conversely, the controller may be configured to ignore the vision data and determine the field characteristic (s) based on the received secondary data when it is determined that the vision data is occluded/obscured.

In several embodiments, the controller may be configured to compare the vision data and the secondary data to determine when the vision data is occluded. Specifically, in such embodiments, the controller may be configured to generate a vision-based representation (e.g., a three-dimensional image, data point table, and/or the like) of the field based on the received vision data and a secondary representation (e.g., a three-dimensional image, data point table, and/or the like) of the field based on the received secondary data. Furthermore, the controller may be configured to identify one or more object(s) present within the vision-based representation of the field. When the identified object(s) appears in the secondary representation of the field, the controller may be configured to determine that the vision data is not occluded/obscured. However, when the identified object(s) does not appear within the secondary representation of field, the controller may be configured to determine that the vision data is occluded/obscured. After determining that the received vision data is occluded/obscured, the controller may be configured to continue monitoring the vision-based representation of the field for the presence of the identified object(s). When the identified object(s) is no longer present within the vision-based representation of the field, the controller may be configured to determine that the vision data is no longer occluded.

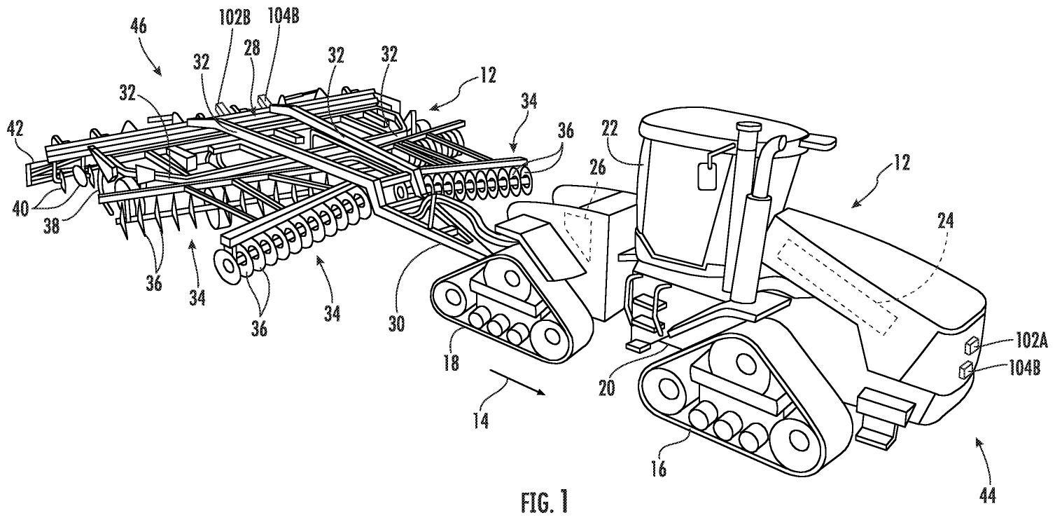

Referring now to the drawings, FIG. 1 illustrates a perspective view of one embodiment of an agricultural machine in accordance with aspects of the present subject matter. As shown, in the illustrated embodiment, the agricultural machine corresponds to a work vehicle 10 and an associated agricultural implement 12. In general, the work vehicle 10 may be configured to tow the implement 12 across a field in a direction of travel (e.g., as indicated by arrow 14 in FIG. 1). As such, in one embodiment, the work vehicle 10 may be configured as an agricultural tractor and the implement 12 may be configured as a tillage implement. However, in other embodiments, the work vehicle 10 may be configured as any other suitable type of vehicle, such as an agricultural harvester, a self-propelled sprayer, and/or the like. Similarly, the implement 12 may be configured as any other suitable type of implement, such as a planter. Furthermore, it should be appreciated that the agricultural machine may correspond to any suitable powered and/or unpowered agricultural machine (including suitable vehicles and/or equipment, such as only a work vehicle or only an implement). Additionally, the agricultural machine may include more than two machines (e.g., a tractor, a planter, and an associated air cart) coupled to a work vehicle.

As shown in FIG. 1, the work vehicle 10 may include a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices (e.g., a user interface) for permitting an operator to control the operation of one or more components of the work vehicle 10 and/or one or more components of the implement 12. Additionally, the work vehicle 10 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

Additionally, as shown in FIG. 1, the implement 12 may generally include a frame 28 configured to be towed by the vehicle 10 via a pull hitch or tow bar 30 in the direction of travel 14. In general, the frame 28 may include a plurality of structural frame members 32, such as beams, bars, and/or the like, configured to support or couple to a plurality of components. As such, the frame 28 may be configured to support a plurality of ground-engaging tools, such as a plurality of shanks, disk blades, leveling blades, basket assemblies, tines, spikes, and/or the like. In one embodiment, the various ground-engaging tools may be configured to perform a tillage operation or any other suitable ground-engaging operation on the field across which the implement 12 is being towed. For example, in the illustrated embodiment, the frame 28 is configured to support various gangs 34 of disc blades 36, a plurality of ground-engaging shanks 38, a plurality of leveling blades 40, and a plurality of crumbler wheels or basket assemblies 42. However, in alternative embodiments, the frame 28 may be configured to support any other suitable ground-engaging tool(s) or combinations of ground-engaging tools.

In accordance with aspects of the present subject matter, the vehicle/implement 10/12 may include one or more vision-based sensors coupled thereto and/or mounted thereon. As will be described below, each vision-based sensor may be configured to capture vision data associated with a portion of the field across which the vehicle/implement 10/12 is traveling. Such vision data may, in turn, be indicative of one or more field characteristics of the field, such as the residue coverage, the clod size, or the soil roughness of the field. As such, in several embodiments, the vision-based sensor(s) may be provided in operative association with the vehicle/implement 10/12 such that the associated sensor(s) has a field of view or sensor detection range directed towards a portion(s) of the field adjacent to the vehicle/implement 10/12. For example, as shown in FIG. 1, in one embodiment, one vision-based sensor 102A may be mounted on a forward end 44 of the work vehicle 10 to capture vision data associated with a section of the field disposed in front of the vehicle 10 relative to the direction of travel 14. Similarly, as shown in FIG. 1, a second vision-based sensor 102B may be mounted on an aft end 46 of the implement 12 to capture vision data associated with a section of the field disposed behind the implement 12 relative to the direction of travel 14. However, in alternative embodiments, the vision-based sensors 102A, 102B may be installed at any other suitable location(s) on the vehicle/implement 10/12. Additionally, in some embodiments, the vehicle/implement 10/12 may include only one vision-based sensor or three or more vision-based sensors.

Furthermore, the vehicle/implement 10/12 may include one or more secondary sensors coupled thereto and/or mounted thereon. As will be described below, each secondary sensor may be configured to capture secondary data associated with a portion of the field across which the vehicle/implement 10/12 is traveling. Such secondary data may, in turn, be indicative of one or more field characteristics of the field, such as the residue coverage, the clod size, or the soil roughness of the field. As such, in several embodiments, the secondary sensor(s) may be provided in operative association with the vehicle/implement 10/12 such that the associated sensor(s) has a field of view or sensor detection range directed towards a portion(s) of the field adjacent to the vehicle/implement 10/12. For example, as shown in FIG. 1, in one embodiment, one secondary sensor 104A may be mounted on the forward end 44 of the work vehicle 10 to capture secondary data associated with a section of the field disposed in front of the vehicle 10 relative to the direction of travel 14. Similarly, as shown in FIG. 1, a second secondary sensor 104B may be mounted on the aft end 46 of the implement 12 to capture secondary data associated with a section of the field disposed behind the implement 12 relative to the direction of travel 14. Moreover, in some embodiments, the secondary sensors 104A, 104B may be mounted such that the secondary sensors 104A, 104B have the same or similar fields of view as the vision-based sensors 102A, 102B, respectively. As such, the secondary data captured by the secondary sensors 104A, 104B may be associated with the same sections of the field as the vision data captured by the vision-based sensors 102A, 102B. However, in alternative embodiments, the secondary sensors 104A, 104B may be installed at any other suitable location(s) on the vehicle/implement 10/12. Additionally, in some embodiments, the vehicle/implement 10/12 may include only one secondary sensor or three or more secondary sensors.

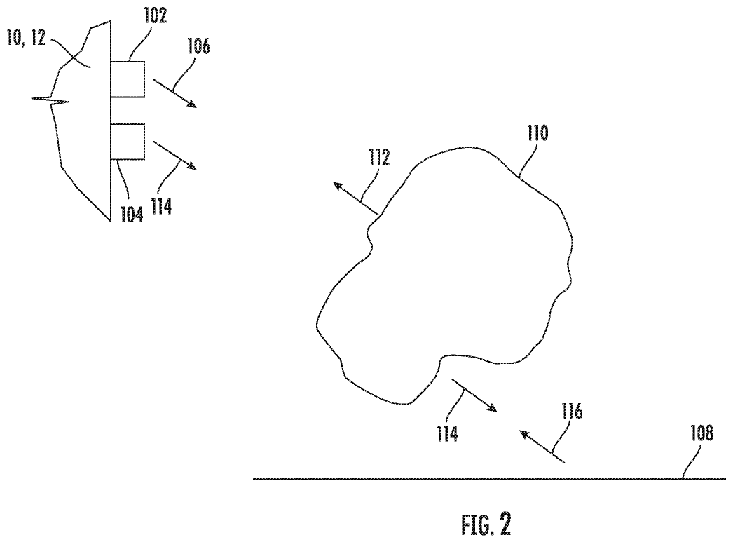

Referring now to FIG. 2, one embodiment of a vision-based sensor 102 and a secondary sensor 102 of the vehicle/implement 10/12 is illustrated in accordance with aspects of the present subject matter. Specifically, in several embodiments, the vision-based sensor 102 may be configured as light detection and ranging (LIDAR) sensor. In such embodiments, as the vehicle/implement 10/12 travel across the field, the vision-based sensor 102 may be configured to emit one or more light/laser output signals (e.g., as indicated by arrows 106 in FIG. 2) for reflection off of an object(s) (e.g., a soil surface 108 of the field, a dust/spray cloud 110, and/or the like) within its field of view. The output signal(s) 106 may, in turn, be reflected by the objects as return signals (e.g., as indicated by arrows 112 in FIG. 2). Moreover, the vision-based sensor 102 may be configured to receive the reflected return signals 112 and generate a plurality of data points (e.g., a data point cloud) based on the received return signal(s) 112. Each data point may, in turn, be indicative of the distance between the vision-based sensor 102 and the object off which one of the return signals 112 is reflected. As will be described below, in certain instances, a controller may be configured to determine one or more field characteristics (e.g., residue coverage, clod size, or soil roughness, and/or the like) based on the plurality of data points generated by the vision-based sensor 102. However, in alternative embodiments, the vision-based sensor 102 may correspond to any other suitable type of vision-based sensing device, such as a camera.

Additionally, in several embodiments, the secondary sensor 104 may be configured as radio detection and ranging (RADAR) sensor. In such embodiments, as the vehicle/implement 10/12 travel across the field, the secondary sensor 104 may be configured to emit one or more radio output signals (e.g., as indicated by arrows 114 in FIG. 2) for reflection off of an object(s) (e.g., the soil surface 108 and/or the like) within its field of view. The output signal(s) 114 may, in turn, be reflected by the objects as return signals (e.g., as indicated by arrows 116 in FIG. 2). Moreover, the secondary sensor 104 may be configured to receive the reflected return signals 116 and generate a plurality of data points (e.g., a data point cloud) based on the received return signal(s) 116. Each data point may, in turn, be indicative of the distance between the secondary sensor 104 and the object off which one of the return signals 116 is reflected. As will be described below, in certain instances, a controller may be configured to determine one or more field characteristics (e.g., residue coverage, clod size, or soil roughness, and/or the like) based on the plurality of data points generated by the secondary sensor 104. However, in alternative embodiments, the secondary sensor 104 may correspond to any other suitable type of sensing device, such as an ultrasonic sensor.

In general, the performance of an agricultural operation (e.g., a tillage operation, a spraying operation, and/or the like) may generate dust clouds, spray clouds, and/or other airborne particulate matter. As such, in certain instances, a dust/spray cloud 108 may be present within the fields of view of the vision-based sensor 102 and the secondary sensor 104. As shown in FIG. 2, the output signal(s) 106 emitted by the vision-based sensor 102 may be reflected by the dust/spray cloud 110 instead of the soil surface 108. In such instances, the vision data captured by the vision-based sensor 102 may be occluded such that the vision data does not provide an accurate indication of the characteristics of the field on which the agricultural operation is being performed. However, the output signal(s) 114 emitted by the secondary sensor 104 may pass through the dust/spray cloud 110 for reflection off of the soil surface 108. In this regard, the secondary data captured by the secondary sensor 104 may provide an accurate indication of the field characteristics of the field even when the dust/spray cloud 110 is present within the field of view of the secondary sensor 104.

It should be further appreciated that the configuration of the work vehicle 10 and the agricultural implement 12 described above and shown in FIGS. 1 and 2 is provided only to place the present subject matter in an exemplary field of use. Thus, it should be appreciated that the present subject matter may be readily adaptable to any manner of agricultural machine configuration.

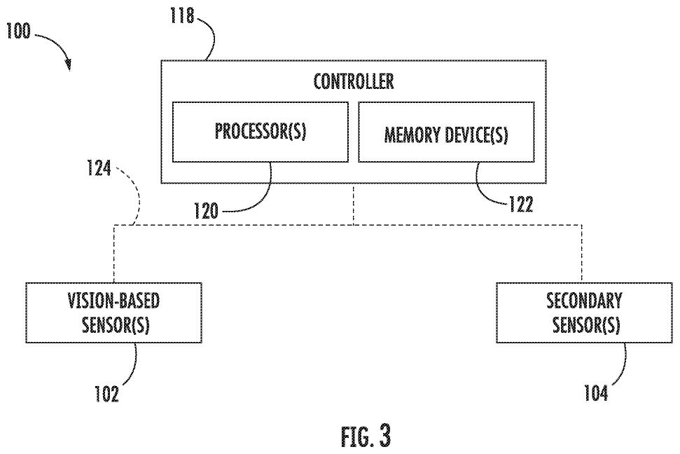

Referring now to FIG. 3, a schematic view of one embodiment of a system 100 for determining field characteristics during the performance of an agricultural operation is illustrated in accordance with aspects of the present subject matter. In general, the system 100 will be described herein with reference to the work vehicle 10 and the agricultural implement 12 described above with reference to FIGS. 1 and 2. However, it should be appreciated by those of ordinary skill in the art that the disclosed system 100 may generally be utilized with agricultural machines having any other suitable machine configuration.

As shown in FIG. 3, the system 100 may include a controller 118 positioned on and/or within or otherwise associated with the vehicle 10 or the implement 12. In general, the controller 118 may comprise any suitable processor-based device known in the art, such as a computing device or any suitable combination of computing devices. Thus, in several embodiments, the controller 118 may include one or more processor(s) 120 and associated memory device(s) 122 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 122 of the controller 118 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 122 may generally be configured to store suitable computer-readable instructions that, when implemented by the processor(s) 120, configure the controller 118 to perform various computer-implemented functions.

In addition, the controller 118 may also include various other suitable components, such as a communications circuit or module, a network interface, one or more input/output channels, a data/control bus and/or the like, to allow controller 118 to be communicatively coupled to any of the various other system components described herein (e.g., the vision-based sensor(s) 102 and the secondary sensor(s) 104). For instance, as shown in FIG. 3, a communicative link or interface 124 (e.g., a data bus) may be provided between the controller 118 and the sensors 102, 104 to allow the controller 118 to communicate with such sensors 102, 104 via any suitable communications protocol (e.g., CANBUS).

It should be appreciated that the controller 118 may correspond to an existing controller(s) of the vehicle 10 and/or the implement 12, itself, or the controller 118 may correspond to a separate processing device. For instance, in one embodiment, the controller 118 may form all or part of a separate plug-in module that may be installed in association with the vehicle 10 and/or the implement 12 to allow for the disclosed systems to be implemented without requiring additional software to be uploaded onto existing control devices of the vehicle 10 and/or the implement 12. It should also be appreciated that the functions of the controller 118 may be performed by a single processor-based device or may be distributed across any number of processor-based devices, in which instance such devices may be considered to form part of the controller 118. For instance, the functions of the controller 108 may be distributed across multiple application-specific controllers, such as an engine controller, a transmission controller, an implement controller, and/or the like.

In several embodiments, the controller 118 may be configured to receive vision data from one or more vision-based sensors 102 and secondary data from one or more secondary sensors 104. As described above, the vehicle/implement 10/12 may include one or more vision-based sensors 102 (e.g., a LIDAR sensor(s)), with each vision-based sensor 102 configured to capture vision data of a portion of the field within its field of view. Moreover, the vehicle/implement 10/12 may include secondary sensors 104 (e.g., a RADAR sensor(s)), with each secondary sensor 104 configured to capture secondary data of a portion of the field within its field of view. In this regard, as the vehicle/implement 10/12 travels across the field, the controller 118 may be configured to receive the vision data from the vision-based sensor(s) 102 (e.g., via the communicative link 124) and the secondary data from the secondary sensor(s) 104 (e.g., via the communicative link 124). As will be described below, the controller 118 may be configured to determine one or more characteristics (e.g., the residue coverage, the clod size, the soil roughness, and/or the like) of the field across which the vehicle/implement 10/12 is traveling based on the received vision data or secondary data.

Furthermore, in several embodiments, the controller 118 may be configured to generate a vision-based representation of the field across which the vehicle/implement 10/12 is traveling. In general, the vision-based representation of the field may provide an indication of the location and/or profile of the objects (e.g., the soil surface 108 of the field) currently present within the field(s) of view of the vision-based sensor(s) 102. The vision-based representation of the field may further be indicative one or more characteristics (e.g., the residue coverage, the clod size, the soil roughness, and/or the like) of the field. In several embodiments, the controller 118 may be configured to analyze/process the received vision data (e.g., the captured data point cloud) to generate the vision-based representation of the field. As such, the controller 118 may include a suitable algorithm(s) stored within its memory device(s) 122 that, when executed by the processor(s) 120, generates the representation of the field from the vision data received from the vision-based sensor(s) 102.

Additionally, in one embodiment, the controller 118 may be configured to generate a secondary representation of the field across which the vehicle/implement 10/12 is traveling. In general, the secondary representation of the field may provide an indication of the location and/or profile of the objects (e.g., the soil surface 108 of the field) currently present within the field(s) of view of the secondary sensor(s) 104. The secondary representation of the field may further be indicative one or more characteristics (e.g., the residue coverage, the clod size, the soil roughness, and/or the like) of the field. In several embodiments, the controller 118 may be configured to analyze/process the received secondary data (e.g., the captured data point cloud) to generate the secondary representation of the field. As such, the controller 118 may include a suitable algorithm(s) stored within its memory device(s) 122 that, when executed by the processor(s) 120, generates the representation of the field from the secondary data received from the secondary sensor(s) 104.

It should be appreciated that, as used herein, the “representation of the field” may correspond to any suitable data structure that correlates the received sensor data to various locations within the field. For example, in several embodiments, the vision-based and/or secondary representations of the field may correspond to a three-dimensional images or spatial models having a three-dimensional arrangement of captured data points. More specifically, as described above, the vision-based sensor(s) 102 and the secondary sensor(s) 104 may be configured to capture a plurality of data points, with each data point being indicative of the location of a portion of an object within the field of view of the corresponding sensor. In such embodiments, the controller 118 may be configured to position each captured data point within a three-dimensional space corresponding to the field(s) of view of the vision-based sensor(s) 102 and/or secondary sensor(s) 104 to generate the three-dimensional image(s). As such, groups of proximate data points within the generated image(s)/models(s) may illustrate the location(s) and/or profile(s) of the object(s) currently present within the field(s) of view of the vision-based sensor(s) 102 and/or secondary sensor(s) 104. However, in alternative embodiments, the representation(s) of the field may correspond to any other suitable type of data structure, such as data table(s).

In accordance with aspects of the present subject matter, the controller 118 may be configured to determine when the received vision data is occluded or otherwise obscured. In general, the vision data may be occluded or obscured when the field conditions are such that the captured vision data is of reduced quality. Such reduced quality vision data may, in turn, provide an inaccurate indication of one or more characteristics (e.g., the residue coverage, the clod size, the soil roughness, and/or the like) of the field. Such field conditions may include dust clouds or other airborne particulate matter, spray clouds, low ambient lighting, and/or the like. When it is determined that the vision data is not occluded/obscured, the controller 118 may be configured to determine the field characteristics based on the received vision data (e.g., the generated vision-based representation of the field). Conversely, the controller 118 may be configured to determine the field characteristics based on the received secondary data when it is determined that the vision data is occluded/obscured.

In several embodiments, the controller 118 may be configured to analyze the generated vision-based representation of the field to determine when the vision data is obscured/obscured. In certain instances, as the vehicle/implement 10/12 travels across the field, a dust/spray cloud(s) may be present within the field(s) of view of the vision-based sensor(s) 102 and the secondary sensor(s) 104. For example, as shown in FIG. 2, a dust/spray cloud 108 may be located between the sensors 102, 104 and the soil surface 108 of the field. In such instances, the output signal(s) 106 emitted by the vision-based sensor(s) 102 may be reflected by dust/spray clouds, thereby causing the dust/spray cloud to appear as an object within the vision-based representation of the field. However, the output signal(s) 114 emitted by the secondary sensor(s) 104 may penetrate the dust/spray cloud such that the dust/spray cloud does not appear within the secondary representation of the field. As such, the controller 118 may be configured to analyze the vision-based representation of the field to identify one or more objects therein. Thereafter, the controller 118 may be configured to determine whether the object(s) identified within the vision-based representation of the field is present within the secondary representation of the field. When the object(s) identified within the vision-based representation of the field appear within the secondary representation of the field (thereby indicating the object reflected the output signals 106, 114 emitted by vision-based and secondary sensor 102, 104), the controller 118 may determine that the object present within the vision-based and secondary representations of the field is a solid object or obstacle. In such instances, the controller 118 may be configured to may determine that the captured vision data is not occluded/obscured. However, when the object(s) identified within the vision-based representation of the field does not appear within the secondary representation of the field (thereby indicating the object reflected the output signal(s) 106 emitted by vision-based sensor 102, but not the output signal(s) 114 emitted by the secondary sensor 104), the controller 118 may determine that the object(s) present within the vision-based representation of the field is a dust/spray cloud(s). In such instances, the controller 118 may be configured to determine that the captured vision data is occluded/obscured.

It should be appreciated that the controller 118 may be configured to identify objects present within the vision-based and secondary representations of the field in any suitable manner. For instance, the controller 118 may include a suitable algorithm(s) stored within its memory 122 that, when executed by the processor 120, identifies objects within the vision-based and secondary representations of the field. In one embodiment, the controller 118 may perform a classification operation on the data points of the vision-based and secondary representations of the field to extract feature parameters that may be used to identify any objects therein (e.g. using classification methods, such as k-nearest neighbors search, naive Bayesian classifiers, convoluted neural networks, support vector machines, and/or the like).

In one embodiment, the controller 118 may be configured to generate the secondary representation of the field when an object(s) has been identified within the vision-based representation of the field. In such an embodiment, the controller 118 may be configured to ignore the received secondary data until an object(s) has been identified within the vision-based representation of the field. Once an object(s) has been identified within the vision-based representation of the field, the controller 118 may be configured to generate the secondary representation of the field for use in determining whether the vision data is occluded/obscured. Such a configuration may reduce the processing power and memory requirements of the controller 118 by not generating the secondary representation of the field until such representation is needed. However, in alternative embodiments, the controller 118 may be configured to generate the secondary representation of the field simultaneously or otherwise is parallel with the vision-based representation of the field.

In another embodiment, the controller 118 may be configured to determine when the received vision data is occluded/obscured based on the location of the data points forming the vision-based representation of the field. In general, the soil surface of the field and/or any crops growing therein may be expected to have a predetermined range of positions relative to the vision-based sensor(s) 102. As such, the data points associated with the soil surface and/or any crops growing within the field may generally be located at a particular range positions within the vision-based representation of the field. Conversely, any data points located outside of such range of positions within the vision-based representation of the field may be assumed to be indicative of or otherwise associated with dust/spray clouds. In this regard, the controller 118 may be configured to compare the position of each data point within the vision-based representation of the field to a predetermined range of positions associated with the soil surface of or the crops within of the field. Thereafter, when one or more data points of the vision-based representation of the field fall outside of the predetermined range of positions, the controller 122 may be configured to determine that the vision data is occluded/obscured.

In certain instances, the overall accuracy of the vision data may not be adversely affected by a small number of individual data points of the vision-based representation of the field that are outside of the predetermined range of positions, particularly when such data points are distributed across the representation of the field. However, several data points all located proximate to each other that are outside of the predetermined range of positions may impact the overall accuracy of the vision data. As such, in several embodiment, the controller 118 may be configured to determine when the vision data is occluded based on the variability of the data points within the vision-based representation of the field. For example, in one embodiment, the controller 118 may be configured to determine a density of the data points within the vision-based representation of the field. When the determined density exceeds a predetermined density threshold (thereby indicating that accuracy of the vision has been impacted), the controller 118 may to determine that the vision data is occluded/obscured.

Additionally, as indicated above the controller 118 may be configured to determine one or more characteristics of the field based on the received vision data or the received secondary data. Such field characteristic(s) may include residue coverage, clod size, soil roughness, and/or the like. In general, the received vision data (e.g., LIDAR data) may have a greater resolution than the received secondary data (e.g., RADAR data). In this regard, the vision data may generally provide a better or more accurate indication of the field characteristic(s) than the secondary data. As such, when it is determined that the vision data is not occluded/obscured, the controller 118 may be configured to determine the field characteristic(s) based on the received vision data (e.g., the vision-based representation of the field). In such instances, the controller 118 may be configured to ignore the received secondary data. However, when it is determined that the vision data is occluded/obscured (e.g., the vision data indicates the presence of a dust/spray cloud), the controller 118 may be configured to determine the field characteristic(s) based on the received secondary data (e.g., the secondary representation of the field). For instance, the controller 118 may include a suitable algorithm(s) stored within its memory 122 that, when executed by the processor 120, determines the field characteristic(s) based on the received vision or secondary data.

Furthermore, in one embodiment, once the received vision data is no longer occluded/obscured, the controller 118 may be configured to switch back to using the vision data for determining the field characteristic(s). In certain instances, the dust/spray cloud(s) present within the field(s) of view of the vision-based sensor(s) 102 may disappear (e.g., due to continued movement of the vehicle/implement 10/12) such that the captured vision data is no longer obscured. As such, after it is determined that the received vision data is occluded, the controller 118 may be configured to continue monitoring the vision-based representation of the field for the presence of the identified object(s) or other indicator(s) of occlusion. When such object(s)/indicator(s) are no longer present within the vision-based representation of the field, the controller 118 may be configured to determine that the vision data is no longer occluded. In such instances, the controller 118 may be configured to ignore the received secondary data and determine the field characteristic(s) based on the received vision data.

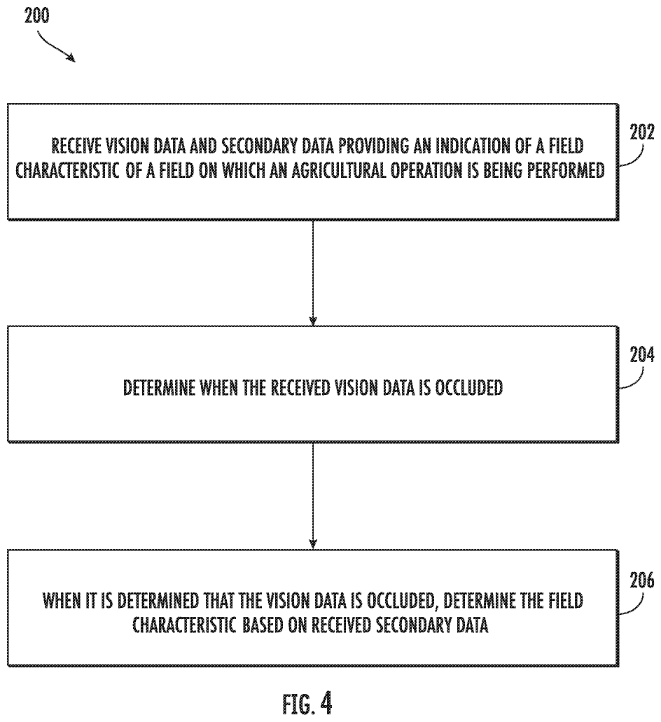

Referring now to FIG. 4, a flow diagram of one embodiment of a method 200 for determining field characteristics during the performance of an agricultural operation is illustrated in accordance with aspects of the present subject matter. In general, the method 200 will be described herein with reference to the work vehicle 10, the agricultural implement 12, and the system 100 described above with reference to FIGS. 1-3. However, it should be appreciated by those of ordinary skill in the art that the disclosed method 200 may generally be implemented with any agricultural machines having any suitable machine configuration and/or any system having any suitable system configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), the method 200 may include receiving, with one or more computing devices, vision data and secondary data providing an indication of a field characteristic of a field on which an agricultural operation is being performed. For instance, as described above, the controller 118 may be configured to receive vision data from one or more vision-based sensors 102 and secondary data from one or more secondary sensors 104. The received vision data and secondary data may, in turn, be indicative of one or more field characteristics (e.g., a residue characteristic, a clod size, a soil roughness, and/or the like) of the field on which an agricultural operation is being performed.

Additionally, at (204), the method 200 may include determining, with the one or more computing devices, when the received vision data is occluded. For instance, as described above, the controller 118 may be configured to determine when the received vision data is occluded.

Moreover, at (206), when it is determined that the vision data is occluded, the method 200 may include determining, with the one or more computing devices, the field characteristic based on received secondary data. For instance, as described above, when it is determined that the vision data is occluded, the controller 118 may be configured to the field characteristic(s) based on received secondary data.

It is to be understood that the steps of the method 200 are performed by the controller 118 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 118 described herein, such as the method 200, is implemented in software code or instructions which are tangibly stored on a tangible computer readable medium. The controller 118 loads the software code or instructions via a direct interface with the computer readable medium or via a wired and/or wireless network. Upon loading and executing such software code or instructions by the controller 118, the controller 118 may perform any of the functionality of the controller 118 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for determining field characteristics during the performance of an agricultural operation, the system comprising:
an agricultural machine configured to perform an agricultural operation on a field across which the agricultural machine is traveling;
a vision-based sensor provided in operative association with the agricultural machine having a field of view of a section of the field, the vision-based sensor configured to capture vision data indicative of a field characteristic of the field;
a secondary sensor provided in operative association with the agricultural machine having substantially the same field of view of the section of the field as the vision-based sensor, the secondary sensor configured to capture secondary data indicative of the field characteristic wherein the secondary sensor is a non-vision-based sensor; and
a controller communicatively coupled to the vision-based sensor and the secondary sensor, the controller configured to, as the vehicle performs the agricultural operation:
receive the vision data from the vision-based sensor and secondary data from the secondary sensor for use in determining the field characteristic;
determine whether an object has been detected within the field of view based on the received vision data;
responsive to non detection of an object within the field of view based on the received vision data, determine the field characteristic based on the received vision data; and
responsive only to a detection of an object within the field of view based on the received vision data:
determine when the received vision data is occluded based on a comparison of the received vision data and the received secondary data;
when it is determined that the received vision data is occluded, determine the field characteristic based on the received secondary data; and
when it is determined that the vision data is not occluded, determine the field characteristic based on the vision data.

2. The system of claim 1, wherein the controller is further configured to generate a vision-based representation of the field based on the received vision data.

3. The system of claim 2, wherein determining when the received vision data is occluded, comprises:
generating a secondary representation of the field based on the received secondary data;
determining whether the object is present within the secondary representation of the field; and
when it is determined that the object is not present within the secondary representation of the field, determining that the received vision data is occluded.

4. The system of claim 3, wherein the controller is further configured to generate the secondary representation of the field after the presence of the object within the vision-based representation is identified.

5. The system of claim 3, wherein the controller is further configured to simultaneously generate the secondary representation of the field and the vision-based representation of the field.

6. The system of claim 2, wherein the vision-based representation of the field comprising a plurality of data points, the controller further configured to determine when the received vision data is occluded based on a location of each data point of the plurality of data points.

7. The system of claim 2, wherein the vision-based representation of the field comprising a plurality of data points, the controller further configured to determine when the received vision data is occluded based on a variability of the plurality of data points.

8. The system of claim 1, wherein, after it is determined that the vision data is occluded, the controller is further configured to determine when the received vision data is no longer occluded.

9. The system of claim 8, wherein, when it is determined that the vision data is no longer occluded, the controller is further configured to:
ignore the secondary data; and
determine the field characteristic based on the vision data.

10. The system of claim 1, wherein the field characteristic comprising at least one of a residue characteristic, a clod size, or a soil roughness of the field.

11. The system of claim 1, wherein the vision-based sensor comprises at least one of a LIDAR sensor, a camera, or a stereo camera, and wherein the secondary sensor comprises at least one of a RADAR sensor or an ultrasonic sensor.

12. A method for determining field characteristics during the performance of an agricultural operation, the method comprising:
receiving, with one or more computing devices, vision data from a vision-based sensor and secondary data from a non-vision-based sensor, wherein each of the vision data and secondary data provide an indication of a field characteristic of a same section of a field on which the agricultural operation is being performed;
determine whether an object has been detected within the field of view based on the received vision data; and
if an object is not detected within the field of view based on the received vision data, determining the field characteristic based on the received vision data;
only if an object is detected within the field of view based on the received vision data:
determining, with the one or more computing devices, when the received vision data is occluded based on a comparison of the received vision data and the received secondary data;
when it is determined that the received vision data is occluded, determining, with the one or more computing devices, the field characteristic based on the received secondary data; and
when it is determined that the vision data is not occluded, determining, with the one or more computing devices, the field characteristic based on the received vision data.

13. The method of claim 12, further comprising:
generating, with the one or more computing devices, a vision-based representation of the field based on the received vision data.

14. The method of claim 13, wherein determining when the vision data is occluded further comprises:
generating, with the one or more computing devices, a secondary representation of the field based on the received secondary data;
determining, with the one or more computing devices, when the object is present within the secondary representation of the field; and
when it is determined that the object is not present within the secondary representation of the field, determining, with the one or more computing devices, that the received vision data is occluded.

15. The method of claim 14, wherein generating the secondary representation of the field further comprises generating, with the one or more computing devices, the secondary representation of the field after the presence of the object within the vision-based representation is identified.

16. The method of claim 14, wherein generating the secondary representation of the field further comprises simultaneously generating, with the one or more computing devices, the secondary representation of the field and the vision-based representation of the field.

17. The method of claim 13, wherein:
the vision-based representation of the field comprises a plurality of data points; and
determining when the received vision data is occluded further comprises determining, with the one or more computing devices, when the received vision data is occluded based on a location of each data point of the plurality of data points.

18. The method of claim 13, wherein:
the vision-based representation of the field comprising a plurality of data points; and
determining when the received vision data is occluded further comprises determining, with the one or more computing devices, when the received vision data is occluded based on a variability of the plurality of data points.

19. The method of claim 12, wherein, after it is determined that the vision data is occluded, the method further comprises:
determining, with the one or more computing devices, when the received vision data is no longer occluded.

20. The method of claim 19, wherein, when it is determined that the vision data is no longer occluded, the method further comprises:
ignoring, with the one or more computing devices, the secondary data; and
determining, with the one or more computing devices, the field characteristic based on the vision data.
